(19) United States
(12) Patent Application Publication
(10) Pub. No.: US 2014/0063314 A1
(43) Pub. Date: Mar. 6, 2014

(54) System And Method Of Video Compressive Sensing For Spatial-Multiplexing Cameras

(71) Applicants: Aswin C Sankaranarayanan, Pittsburgh, PA (US); Christoph E. Studer, Houston, TX (US); Richard G. Baraniuk, Houston, TX (US)

(72) Inventors: Aswin C Sankaranarayanan, Pittsburgh, PA (US); Christoph E. Studer, Houston, TX (US); Richard G. Baraniuk, Houston, TX (US)

(21) Appl. No.: 13/778,106

(22) Filed: Feb. 26, 2013

Related U.S. Application Data
(60) Provisional application No. 61/604,095, filed on Feb. 28, 2012.

(51) Int. Cl. H04N 5/232

(52) U.S. Cl. CPC H04N 5/23293
USPC 348/333.02; 348/333.11

(57) ABSTRACT

Compressive sensing (CS)-based spatial-multiplexing cameras (SMCs) sample a scene through a series of coded projections using a spatial light modulator and a few optical sensor elements. A co-designed video CS sensing matrix and recovery algorithm provides an efficiently computable low-resolution video preview. The scene's optical flow is estimated from the preview and fed into a convex-optimization algorithm to recover the high-resolution video.

### CROSS-REFERENCE TO RELATED APPLICATIONS

The present application claims the benefit of the filing date of U.S. Provisional Patent Application Ser. No. 61/604,095 filed by the present inventors on Feb. 28, 2012.

The aforementioned provisional patent application is hereby incorporated by reference in its entirety.

### STATEMENT REGARDING FEDERALLY SPONSORED RESEARCH OR DEVELOPMENT

This invention was made with government support under Grant Number N66001-11-C-4092 awarded by the Defense Advanced Research Projects Agency, Grant No. FA9550-09-1-0432 awarded by the Air Force Office of Scientific Research, Grant No. W911NF-09-1-0383 awarded by the Army Research Laboratory and Grant No. N66001-08-1-2065 awarded by the SPAWAR Systems Center (SSC) Pacific. The government has certain rights in the invention.

### BACKGROUND OF THE INVENTION

1. Field of the Invention

The present invention relates to spatial multiplexing cameras, and more particularly, to video compressive sensing for spatial multiplexing cameras.

2. Brief Description of the Related Art

Compressive sensing (CS) enables one to sample well below the Nyquist rate, while still enabling the recovery of signals that admit a sparse representation in some basis. See, E. J. Cand'es, J. Romberg, and T. Tao, “Robust uncertainty principles: Exact signal reconstruction from highly incomplete incomplete frequency information,” IEEE Trans. Inf. Theory, vol. 52, pp. 489-509, February 2006; D. L. Donoho, “Compressed sensing,” IEEE Trans. Inf. Theory, vol. 52, pp. 1289-1306, April 2006; and U.S. Pat. No. 7,271,747. Since many natural (and artificial) signals exhibit sparsity, CS has potential to reduce the sampling rates and costs of corresponding devices in numerous applications.

Compressive sensing deals with the recovery of a signal vector xε [symbol] ^{N} from M<N non-adaptive linear measurements

y=Φx+z, (1)

where Φε [symbol] ^{M×N} is the sensing matrix and z represents measurement noise. Estimating the signal x from the compressive measurements y is ill-posed, in general, since the (noiseless) system of equations y=Φx is underdetermined. Nevertheless, a fundamental result from CS theory states that the signal vector x can be recovered stably from

M˜K log(N/K) (2)

measurements if: i) the signal x admits a K-sparse representation s=Ψ^{T}x in an orthonormal basis Ψ, and ii) the matrix ΦΨ satisfies the restricted isometry property (RIP). For example, if the entries of the matrix Φ are i.i.d. zero mean (sub-)Gaussian distributed, then ΦΨ is known to satisfy the RIP with overwhelming probability. Furthermore, any K-sparse signal x satisfying (2) can be recovered stably from the noisy measurement y by solving a convex optimization problem such as

minimize ∥Ψ^{T}x∥₁ subject to ∥y−Φx∥₂≦ε (P1)

where (•)^{T} denotes matrix transposition and ε controls the accuracy of the estimate.

The single-pixel camera (SPC), the flexible voxels camera, and the P2C2 camera are practical imaging architectures that rely on the theory of CS. See, M. F. Duarte, M. A. Davenport, D. Takhar, J. N. Laska, T. Sun, K. F. Kelly, and R. G. Baraniuk, “Single-pixel imaging via compressive sampling,” IEEE Signal Process. Mag., vol. 25, pp. 83-91, March 2008; M. Gupta, A. Agrawal, A. Veeraraghavan, and S. Narasimhan, “Flexible voxels for motion-aware videography,” in Euro. Conf. Comp. Vision, (Crete, Greece), September 2010; and D. Reddy, A. Veeraraghavan, and R. Chellappa, “P2C2: Programmable pixel compressive camera for high speed imaging,” in IEEE Conf. Comp. Vision and Pattern Recog, (Colorado Springs, CO, USA), June 2011, and U.S. Patent Application Publication No. 2006/0239336.

Spatial-multiplexing cameras (SMCs) are practical imaging architectures that build upon the ideas of CS. Such cameras employ a spatial light modulator, e.g., a digital micro-minor device (DMD) or liquid crystal on silicon (LCOS), to optically calculate a series linear projections of a scene x by implementing the sensing process in (1) above using pseudo-random patterns that ultimately determine the sensing matrix Φ. A prominent example of an SMC architecture is the single-pixel camera (SPC); its main feature is the ability of acquiring images by using only a single sensor element (i.e., a single pixel) and by taking significantly fewer measurements than the number of pixels of the scene to be recovered. Since SMCs rely on only a few sensor elements, they can operate at wavelengths where corresponding full-frame sensors are too expensive. In the recovery stage the image x is recovered from the compressive measurements collected in y. In practice, recovery is performed either by using (P1) above, total variation (TV)-based convex optimization, or greedy algorithms.

One approach for video-CS for SMC architectures relies on the observation that perception of motion is heavily dependent on the spatial resolution of the video. Specifically, for a given scene, reducing its spatial resolution lowers the error caused by a static scene assumption. Simultaneously, decreasing the spatial resolution reduces the dimensionality of the individual video frames. Both properties build the foundation of the multi-scale recovery approach proposed in J. Y. Park and M. B. Wakin, “A multiscale framework for compressive sensing of video,” in Pict. Coding Symp., (Chicago, Ill., USA), May 2009, where several compressive measurements are acquired at multiple scales for each video frame. The recovery of the video at coarse scales (small spatial resolution) is used to estimate motion, which is then used to boost the recovery at finer scales (high spatial resolution). The key drawback of this approach is the fact that it relies on the assumption that each frame of the video remains static during the acquisition of CS measurements at various scales. For scenes violating this assumption—as it is the case in virtually all real-world situations—this approach results in poor quality.

Another recovery method was described in D. Reddy, A. Veeraraghavan, and R. Chellappa, “P2C2: Programmable pixel compressive camera for high speed imaging,” in IEEE Conf. Comp. Vision and Pattern Recog, (Colorado Springs, CO, USA), June 2011 for the P2C2 camera, which differs considerably from SMC architectures, i.e., performs temporal multiplexing (instead of spatial multiplexing) with the aid of a full-frame sensor and a per-pixel shutter. The recovery of videos from the P2C2 camera is achieved by using the optical flow between consecutive frames of the video. The implementation of the recovery procedure, however, is tightly coupled with their imaging architecture and inhibits the use for SMC architectures.

### SUMMARY OF THE INVENTION

The present invention is a compressive-sensing (CS)-based multi-scale video recovery method and apparatus for scenes acquired by spatial multiplexing cameras (SMCs). The invention includes a design of a new class of sensing matrices and an optical flow based video reconstruction algorithm. In particular, the invention includes multi-scale sensing (MSS) matrices that i) exhibit no noise enhancement when performing least-squares estimation at a lower spatial resolution and ii) preserve information about high spatial frequencies to enable recovery of the high-resolution scene. It further includes a MSS matrix having a fast transforms, which enables it to compute instantaneous low-resolution images of the scene at low computational costs. The preview computation supports a large number of novel applications for SMC-based devices, such as providing a digital viewfinder, enabling human-camera interaction, or triggering adaptive sensing strategies. Finally, CS-MUVI is the first video CS algorithm for the SPC that works well for scenes with fast and complex motion.

The performance degradation of recovery of time varying scenes caused by violating the static-scene assumption of conventional systems and methods is severe, even at moderate levels of motion. The present compressive-sensing strategy for SMC architectures overcomes the static-scene assumption. The present system and method, illustrated FIG. 1, is a co-design of video compressive sensing and recovery. The method and system use a novel class of sensing matrices in combination with a least squares (LS) recovery procedure that enable the system and method to obtain a low-resolution “previews” of the scene with very low computational complexity. This preview video is then used to extract robust motion estimates (i.e., the optical flow) of the scene at full resolution. The system and method exploit these motion estimates to recover the full-resolution video by using off-the-shelf convex-optimization algorithms typically used for CS, such as l₁-norm minimization or total variation (TV) methods. Given the multi-scale nature of the present framework, it is referred to herein as CS-based multi-scale video recovery (CS-MUVI).

In a preferred embodiment, the present invention is a method for video compressive sensing for spatial multiplexing cameras. The method comprises the steps of sensing a time-varying scene with a spatial multiplexing camera, computing a least squared estimate of a sensed scene, generating a low-resolution preview video of said sensed scene using a computed least squares estimate of said sensed scene, estimating an optical flow of said time-varying scene using said low-resolution preview video, and recovering a full resolution video of said sensed time-varying scene using sparse signal recovery algorithms. A generated low-resolution preview video may be displayed on a display. The method may further comprise displaying a recovered full resolution video of said time-varying scene. The step of sensing a time-varying scene with a spatial multiplexing camera may comprise, for example sensing a time-varying scene with a single pixel camera, a flexible voxels camera or a P2C2 camera.

Many variations may be used with the invention. Sensing patterns used in sensing the time-varying scene are generated using a multi-scale sensing (MSS) matrix. The MSS matrix may have a fast transform when right-multiplied by upsampling operators. The MSS matrix may be designed for two scales. A downsampled version of the sensing matrix may be orthogonal or may have a fast inverse transform. The optical flow may be approximated using block-matching techniques or may be computed using an upsampled version of the preview frames. Information about the scene may be extracted from the low-resolution preview. The extracted information may comprise the location, intensity, speed, distance, orientation, and/or size of objects in the scene. Information about the scene may be taken into account in the recovery procedure of the high-resolution video. Subsequent sensing patterns may be automatically adapted based on extracted information. Parameters (optics, shutter, orientation, aperture etc.) of the spatial multiplexing camera may be automatically or manually adjusted using the extracted information. The dynamic foreground and static background may be separated. The recovery is performed using l1-norm minimization. The recovery may be performed, for example, using total variation minimization or using greedy algorithms.

Still other aspects, features, and advantages of the present invention are readily apparent from the following detailed description, simply by illustrating a preferable embodiments and implementations. The present invention is also capable of other and different embodiments and its several details can be modified in various obvious respects, all without departing from the spirit and scope of the present invention. Accordingly, the drawings and descriptions are to be regarded as illustrative in nature, and not as restrictive. Additional objects and advantages of the invention will be set forth in part in the description which follows and in part will be obvious from the description, or may be learned by practice of the invention.

### BRIEF DESCRIPTION OF THE DRAWINGS

For a more complete understanding of the present invention and the advantages thereof, reference is now made to the following description and the accompanying drawings, in which:

FIG. 1A is a flowchart of CS-MUVI method and system in accordance with a preferred embodiment of the present invention.

FIG. 1B is an illustration of a ground-truth scene consisting of a background (Lena) and a single moving object (cross).

FIG. 1C is a low-resolution preview video generated in accordance with a preferred embodiment of the present invention.

FIG. 1D is an illustration of a high-resolution recovered video in accordance with a preferred embodiment of the present invention.

FIG. 1E shows an exemplary prior art compressive imaging (CI) camera. An incident light field 182 corresponding to the desired image x passes through a lens 184 and is then reflected off a digital micromirror device (DMD) array 188 whose minor orientations are modulated in the pseudorandom pattern sequence supplied by the random number generator or generators 186. Each different mirror pattern travels through a lens 190 and produces a voltage at the single photodiode detector 192 that corresponds to one measurement y(m). While only one photodetector is shown in FIG. 1E, any number of detectors may be used, although typically, the number of photodetectors will be less than the total number of ultimate number of pixels obtained in the image. The voltage level is then quantized by an analog-to-digital converter 194. The bitstream produced is then communicated to a reconstruction algorithm 196, which yields the output scene 198.

FIGS. 2A and 2B illustrate the trade-off between spatial and temporal approximation errors (measured in terms of the CS recovery SNR) for the scene in FIG. 1A. FIG. 2A shows the SNRs caused by spatial and temporal approximation errors for different window lengths W. FIG. 2B shows the dependence of the total approximation error on the speed of the cross.

FIGS. 3A-3C shows a comparison between l₁-norm recovery (FIG. 3A), LS recovery using a subsampled noiselet matrix (FIG. 3B), and LS recovery using a multi-scale sensing (MSS) matrix (FIG. 3C) of the scene in FIG. 1A for various relative speeds (of the cross) and window lengths W.

FIGS. 4A-4C illustrates a preview frames for three different scenes. All previews consist of 64×64 pixels. Preview frames are obtained simply using an inverse Hadamard transform (or any other transform matrix that senses scenes with +1, −1 patterns and has a fast inverse), which opens up a variety of new (real-time) applications for video CS.

FIGS. 5A and 5B illustrate generating a special case of MSS patterns, which enables the reconstruction of frames at two scales. Such dual-scale sensing (DSS) patterns are in accordance with a preferred embodiment of the present invention. FIG. 5A illustrates an outline of the process. FIG. 5B illustrates that in practice, the low-resolution Hadamard is permuted for better incoherence with the sparsifying wavelet basis. Fast generation of the DSS matrix requires us to impose additional structure on the high-frequency patterns. In particular, each sub-block of the high-frequency pattern is forced to be the same, which enables fast computation via convolutions.

FIG. 6 is a flow diagram illustrating CS-MUVI recovery (see also FIG. 1A). Given a total number of T measurements, the measurements are grouped into windows of size ΔW resulting in a total of F=T/ΔW frames. For each frame, a preview is first computed using a window of W≧ΔW neighboring measurements. Then, the optical flow between successive preview frames is computed. Finally, the preview frames are used together with the optical-flow estimates in (PV) to obtain F high-resolution video frames.

FIGS. 7A-7D illustrate CS-MUVI recovery results of a video obtained from a high-speed camera. Shown are frames of (FIG. 7A) the ground truth and (FIG. 7B) the recovered video (PSNR=25:0 dB). The xt and yt slices shown in FIGS. 7C and 7D correspond to the lines of the first frame in FIG. 7A. Preview frames for this video are shown in FIG. 4C. (The xt and yt slices are rotated clockwise by 90 degrees.)

FIGS. 8A-8D illustrate CS-MUVI recovery results of a video obtained from a high-speed camera. Shown are frames of (FIG. 8A) the ground truth and (FIG. 8B) the recovered video (PSNR=20:4 dB). The xt and yt slices shown in FIGS. 8C and 8D correspond to the color-coded lines of the first frame in FIG. 8A. Preview frames for this video are shown in FIG. 4B. (The xt and yt slices are rotated clockwise by 90 degrees.)

FIGS. 9A-9F illustrate a comparison of the algorithm used for the P2C2 camera applied to SMC architectures with CS-MUVI recovery. Shown are frames of naïve l₁-norm reconstruction (FIG. 9A), the resulting optical-flow estimates (FIG. 9B), and the P2C2 recovered video (FIG. 9C. The frames in FIG. 9D correspond to preview frames when using DSS matrices, FIG. 9E are the optical-flow estimates, and FIG. 9F is the scene recovered by CS-MUVI.

### DETAILED DESCRIPTION OF THE PREFERRED EMBODIMENTS

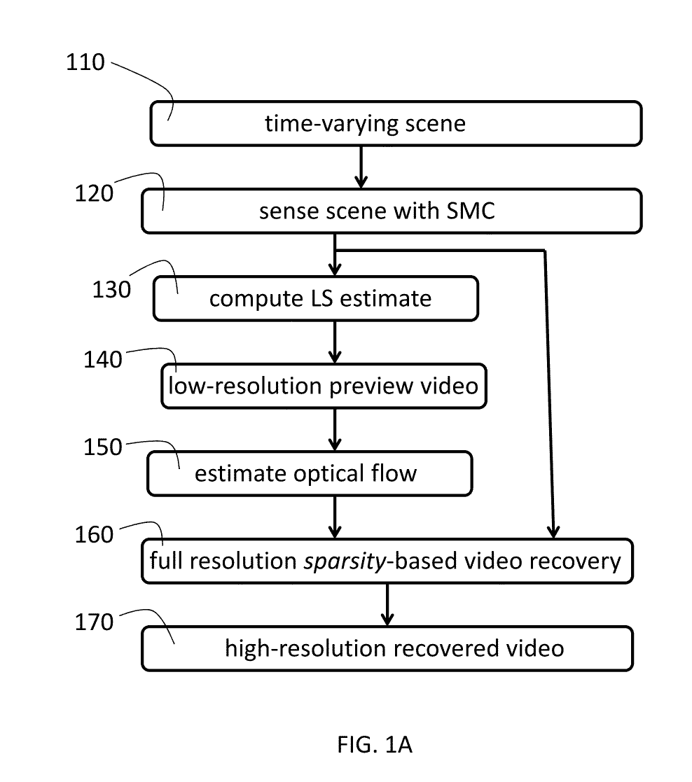

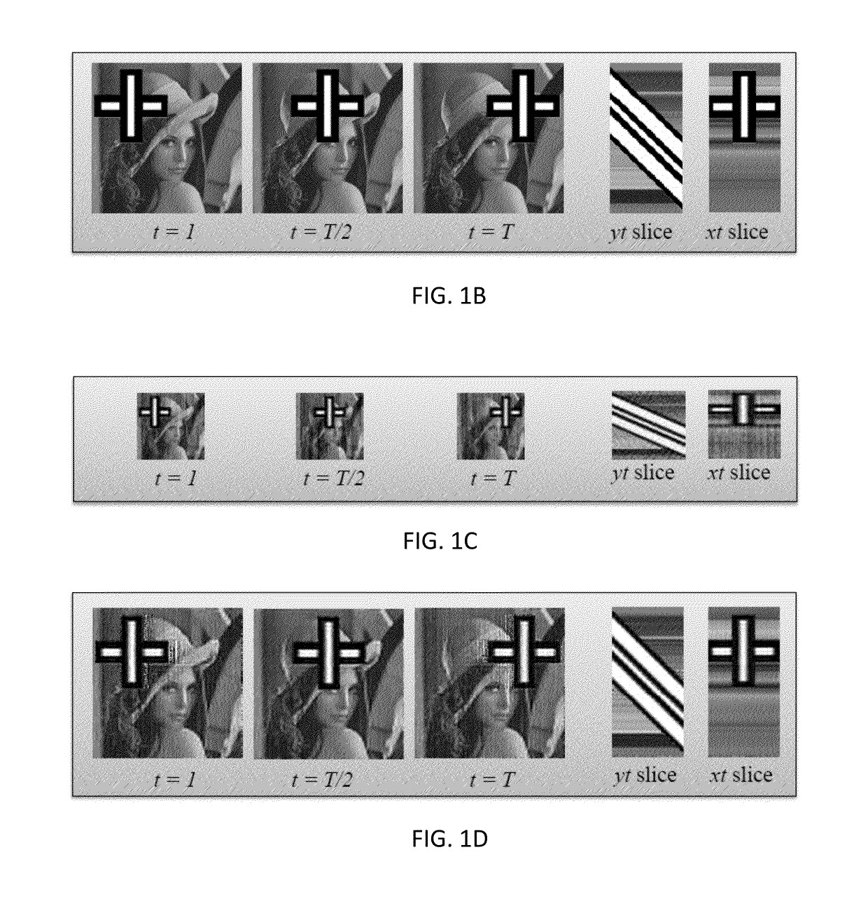

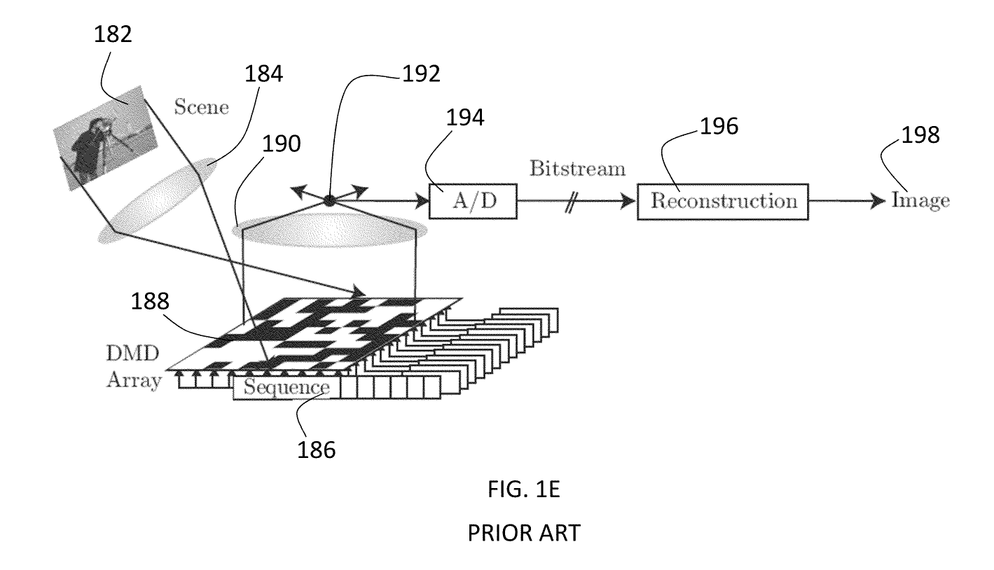

A preferred embodiment of method and apparatus for video compressive sensing for spatial multiplexing cameras is described with reference to the Figures. As shown in FIG. 1A, a time-varying scene (step 110) is senses with a spatial multiplexing camera (step 120). A least squares (LS) estimate is computed, for example, by a processor (step 130), and a low-resolution preview is generated and displayed (step 140). The preview may be generated by, for example, a processor and may be displayed on any display. This preview video is then used to extract robust motion estimates, i.e., estimates of the optical flow of the scene at full resolution (step 150). A full resolution l₁-norm-based video is then recovered (step 160) and the high resolution recovered video is displayed (step 170).

Spatial multiplexing cameras (SMCs) acquire random (or coded) projections of a (typically static) scene using a digital micro-minor device (DMD) or liquid crystal on silicon (LCOS) in combination with a few optical sensing elements, such as photodetectors or bolometers. The use of a small number of optical sensors—in contrast to a full-frame sensor—turns out to be extremely useful when acquiring scenes at non-visible wavelengths. In particular, sensing beyond the visual spectrum requires sensors built from exotic materials, which renders corresponding full-frame sensor devices cumbersome or too expensive.

Obviously, sampling with only a few sensors is, in general, not sufficient for acquiring complex scenes. Hence, SMCs acquire scenes by taking multiple consecutive measurements over time. For still images and for a single-pixel SMC architecture, this sensing strategy has been shown to deliver good results, but it fails for time-variant scenes (videos). The key challenge of video-CS for SMCs is the fact that the scene to be captured is ephemeral, i.e., each compressive measurement senses a (slightly) different scene; the situation is further aggravated when dealing with SMCs having a small number of sensors (e.g., only one for the SPC). Virtually all proposed methods for CS-based video recovery seem to overlook this important aspect. See, for example, J. Y. Park and M. B. Wakin, “A multiscale framework for compressive sensing of video,” in Pict. Coding Symp., (Chicago, Ill., USA), May 2009; A. C. Sankaranarayanan, P. Turaga, R. Baraniuk, and R. Chellappa, “Compressive acquisition of dynamic scenes,” in Euro. Conf. Comp. Vision, (Crete, Greece), September 2010; N. Vaswani, “Kalman filtered compressed sensing,” in IEEE Conf. Image Process., (San Diego, Calif., USA), October 2008; M. B. Wakin, J. N. Laska, M. F. Duarte, D. Baron, S. Sarvotham, D. Takhar, K. F. Kelly, and R. G. Baraniuk, “Compressive imaging for video representation and coding,” in Pict. Coding Symp., (Beijing, China), April 2006; and S. Mun and J. E. Fowler, “Residual reconstruction for block based compressed sensing of video,” in Data Comp. Conf., (Snowbird, UT, USA), April 2011. Indeed, these approaches treat scenes as a sequence of static frames (i.e., videos) as opposed to a continuously changing scene. This disconnectedness between the real-world operation of SMCs and the assumptions commonly made for video CS renders existing recovery algorithms futile.

Successful video-CS recovery methods for camera architectures relying on temporal multiplexing (in contrast to spatial multiplexing as for SMCs) are generally inspired by video compression (i.e., exploit motion estimation). See, for example, D. Reddy, A. Veeraraghavan, and R. Chellappa, “P2C2: Programmable pixel compressive camera for high speed imaging,” in IEEE Conf. Comp. Vision and Pattern Recog, (Colorado Springs, CO, USA), June 2011; A. Veeraraghavan, D. Reddy, and R. Raskar, “Coded strobing photography: Compressive sensing of high speed periodic events,” IEEE Trans. Pattern Anal. Mach. Intell., vol. 33, pp. 671-686, April 2011; and Y. Hitomi, J. Gu, M. Gupta, T. Mitsunaga, and S. K. Nayar, “Video from a single coded exposure photograph using a learned over-complete dictionary,” in IEEE Intl. Conf. Comp. Vision, (Barcelona, Spain), November 2011. The use of such techniques for SMC architectures, however, results in a fundamental problem: On the one hand, obtaining motion estimates (e.g., optical flow or via block matching) requires knowledge of the individual video frames. On the other hand, the recovery of the video frames from an SMC in absence of motion estimates is difficult, especially when using low sampling rates and a small number of sensor elements. Attempts that address this “chicken-and-egg” problem either perform multi scale sensing strategies or sense separate patches of the individual frames. Both approaches ignore the time varying nature of real-world scenes and rely on a piece-wise static model.

A recovery error results from the static-scene assumption while sensing a time-varying scene (video) with an SMC. There is a fundamental tradeoff underlying a multi-scale recovery procedure. Since the single pixel camera is the most challenging SMC architecture (i.e., it only provides a single pixel sensor), it is used herein as an example and generalization of that example to other SMC architectures with more than one sensor is straightforward.

### SMC Acquisition Model

The compressive measurements yₜε [symbol] taken by a single-sensor SMC at the sample instants t=1, . . . , T can be written as yᵣ= [symbol] φₜ,xₜ [symbol] ±zₜ, where T is the total number of acquired samples, φₜε [symbol] ^{N×1} is the sensing vector, zₜε [symbol] is the measurement noise, and xₜε [symbol] ^{N×1} is the scene (or frame) at sample instant t; here, [symbol] •,• [symbol] denotes the inner product. Hereafter, we assume that the 2-dimensional scene consists of n×n spatial pixels, which, when vectorized, results in the vector xₜ of dimension N=n². We also use the notation y₁:w to represent the vector consisting of a window of W≦T successive compressive measurements (samples), i.e,

$${y}_{1 \text{:} W} = [ \begin{matrix}{y}_{1} \\ {y}_{2} \\ ⋮ \\ {y}_{W}\end{matrix} ] = [ \begin{matrix}〈 {φ}_{1} , {x}_{1} 〉 + {z}_{1} \\ 〈 {φ}_{2} , {x}_{2} 〉 + {z}_{2} \\ ⋮ \\ 〈 {φ}_{W} , {x}_{W} 〉 + {z}_{W}\end{matrix} ] . \qquad ( 3 )$$

### Static Scene and Downsampling Errors

Suppose that we rewrite our (time-varying) scene xₜ for a window of W consecutive sample instants as follows:

xₜ=b+Δxₜ, t=1, . . . ,W.

Here, b is a static component (assumed to be invariant for W samples), and Δxₜ=xₜ−b is the error at sample instant t caused by assuming a static scene. By defining eₜ= [symbol] φₜ,Δxₜ [symbol] , we can rewrite (3) as

y_{1:W}=Φb+e_{1:W}+z_{1:W} (4)

where Φε [symbol] ^{W×N} is a sensing matrix whose tth row corresponds to the transposed vector φₜ.

We now consider the error caused by spatial downsampling of the static component b in (4). To this end, let b_{L}ε [symbol] ^{N}^{_{L}} be the down-sampled static component, and assume N_{L}=n_{L}×n_{L} with N_{L}<N. By defining a linear up-sampling and down-sampling operator as Uε [symbol] ^{N×N}^{_{L}} and Dε [symbol] ^{N}^{_{L×N}}, respectively, we can rewrite (4) as

$$\begin{matrix}{y}_{1 \text{:} W} = Φ ( {Ub}_{L} + b - {Ub}_{L} ) + {e}_{1 \text{:} W} + {z}_{1 \text{:} W} \\ = Φ {Ub}_{L} + Φ ( b - {Ub}_{L} ) + {e}_{1 \text{:} W} + {z}_{1 \text{:} W} \\ = Φ {Ub}_{L} + Φ ( I - UD ) b + {e}_{1 \text{:} W} + {z}_{1 \text{:} W}\end{matrix} \qquad ( 5 )$$

since b_{L}=Db. Inspection of (5) reveals three sources of error in the CS measurements of the low-resolution static scene ΦUb_{L}: i) The spatial-approximation error Φ(I-UD)b caused by down-sampling, ii) the temporal approximation error e_{1:W} caused by assuming the scene remains static for W samples, and iii) the measurement error z_{1:W}.

### Estimating a Low Resolution Image

In order to analyze the trade-off that arises from the static-scene assumption and the down-sampling procedure, consider the scenario where the effective matrix ΦU is of dimension W×N_{L} with W≧NL; that is, we aggregate at least as many compressive samples as the down-sampled spatial resolution. If ΦU has full (column) rank, then we can obtain a least-squares (LS) estimate \hat{b}_{L} of the low resolution static scene b_{L} from (5) as

$$\begin{matrix}{\hat{b}}_{L} = {( Φ U )}^{†} {y}_{1 \text{:} W} \\ = {b}_{L} + {( Φ U )}^{†} ( Φ ( I - UD ) b + {e}_{1 \text{:} W} + {z}_{1 \text{:} W} )\end{matrix} \qquad ( 6 )$$

where (•)^{†} denotes the (pseudo) inverse. From (6) we can observe the following facts: i) The window length W controls a trade-off between the spatial-approximation error Φ(I-UD)b and the error e_{1:W} induced by assuming a static scene b, and ii) the least squares (LS) estimator matrix (ΦU)^{†} (potentially) amplifies all three error sources.

### Characterizing the Tradeoff

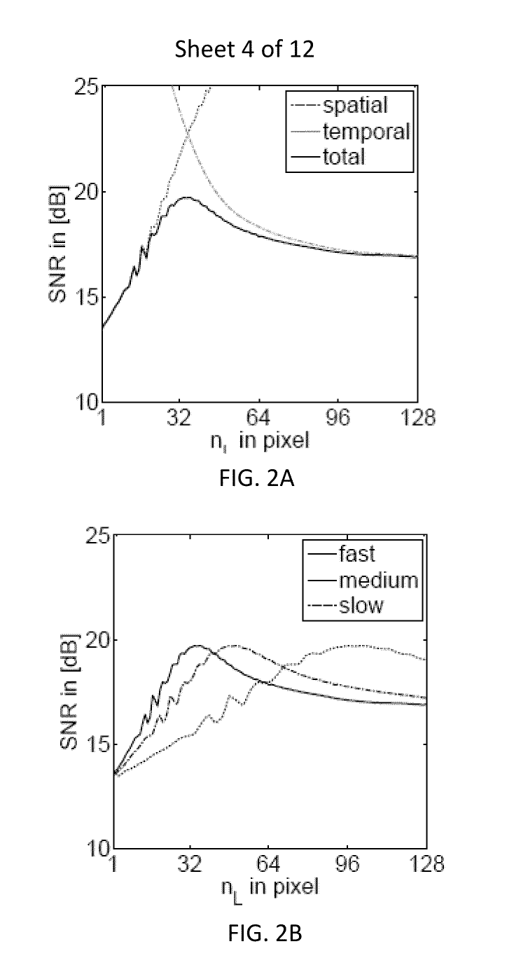

As developed above, the spatial-approximation error and the temporal-approximation error are both a function of the window length W. We now show that carefully selecting W minimizes the combined spatial and temporal error in the low-resolution estimate \hat{b}_{L}. Inspection of (6) shows that for W=1, the temporal-approximation error is zero, since the static component b is able to perfectly represent the scene at each sample instant t. As W increases, the temporal-approximation error increases for time-varying scenes; simultaneously, increasing W reduces the error caused by down-sampling Φ(I-UD)b (see FIG. 2A). For W≧N there is no spatial approximation error (if ΦU is invertible). Note that characterizing both errors analytically is difficult, in general, as they depend on the scene under consideration.

FIGS. 2A and B illustrate the trade-off controlled by W and the individual spatial and temporal approximation errors, characterized in terms of the recovery signal-to-noise-ratio (SNR), for the synthetic scene shown in FIGS. 1B-1D. FIGS. 2A and 2B figure highlight the important fact that there is an optimal window length W for which the total recovery SNR is maximized. In particular, we see from FIG. 2B that the optimum window length increases (i.e., towards higher spatial resolution) when the scene changes slowly; in contrary, when the scene changes rapidly, the window length (and consequently, the spatial resolution) should be low. Since N_{L}≦W, the optimal window length W dictates the resolution for which accurate low-resolution motion estimates can be obtained.

### Design of Sensing Matrix

In order to bootstrap CS-MUVI, a low-resolution estimate of the scene is required. We next now that carefully designing the CS sensing matrix Φ enables us to compute high-quality low-resolution scene estimates at low complexity, which improves the performance of video recovery.

### Multi Scale Sensing Matrices

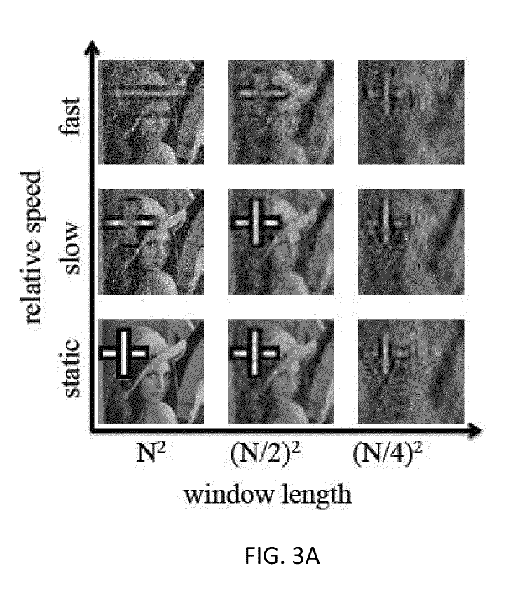

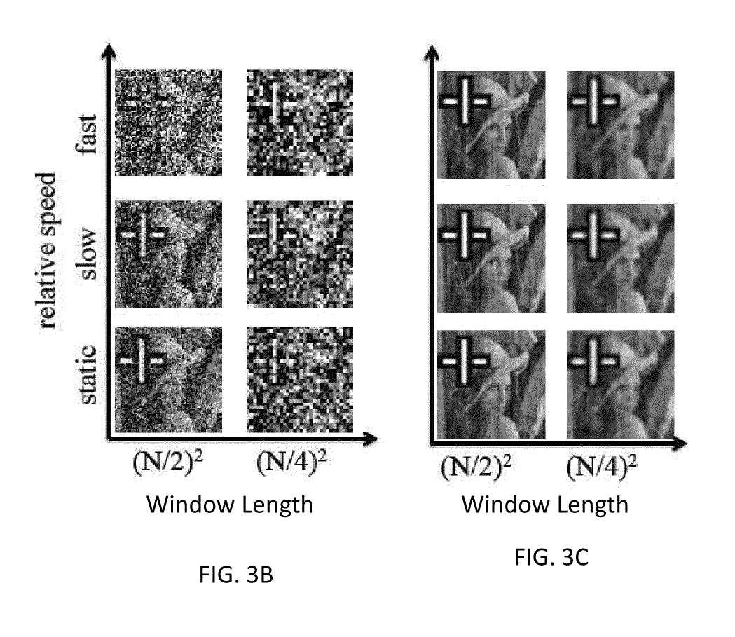

The choice of the sensing matrix Φ and the upsampling operator U are critical to arrive at a high-quality estimate of the low-resolution image b_{L}. Indeed, if the compound matrix ΦU is ill-conditioned, then application of (ΦU)^{†} amplifies all three sources of errors in (6), resulting in a poor estimate. For a large class of conventional CS matrices Φ, such as i.i.d. (sub-)Gaussian matrices, as well as sub-sampled Fourier or Hadamard matrices, right multiplying them with an upsampling operator U typically results in an ill-conditioned matrix. Hence, using well-established CS matrices for obtaining a low-resolution preview turns out to be a poor choice. FIGS. 3A and 3B show recovery results for naive recovery using (P1) and LS, respectively, using a subsampled noiselet CS matrix. One can immediately see that both recovery methods fail spectacularly for large values of W or for a small amount of motion.

In order to achieve good CS recovery performance and have minimum noise enhancement when computing low resolution estimates \hat{b}_{L} according to (6), the present invention uses a new class of sensing matrices, referred to as multi-scale sensing (MSS) matrices. In particular, the present invention uses matrices that i) satisfy the RIP and ii) remain well-conditioned when right-multiplied by certain up-sampling operators U. The second condition requires mutual orthogonality among the columns of ΦU to minimize the noise enhancement in (6). Random matrices or certain sub-sampled orthogonal transforms are known to satisfy the RIP with overwhelming probability. However, they typically fail to meet the second constraint, because they have decaying singular values. The power of MSS matrices with a particular DSS design is demonstrated in FIG. 3C, even for small window lengths W or fast motion.

### Preview Mode

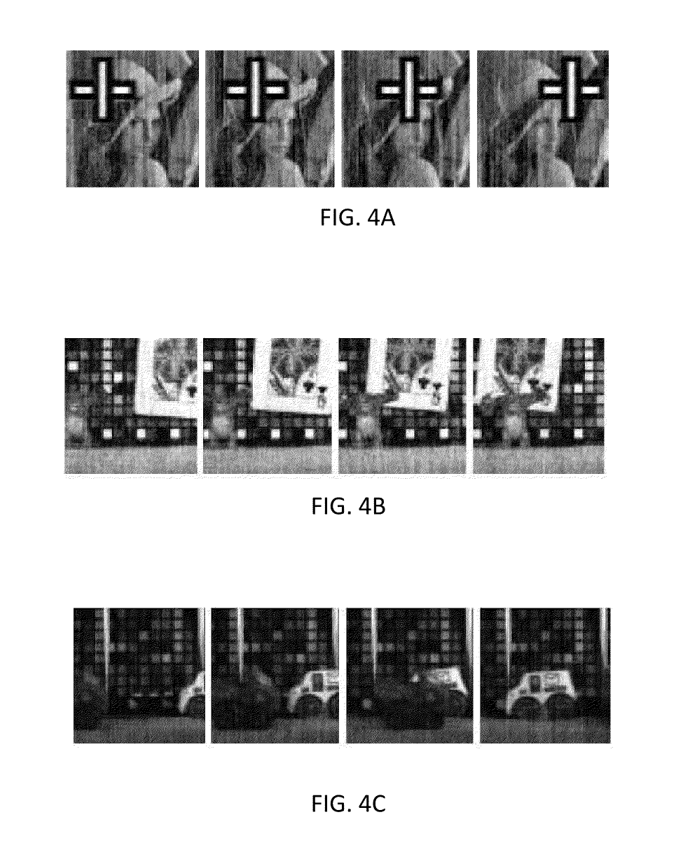

If we additionally impose the constraint that a downsampled MSS matrix ΦU has a fast inverse transform, then it will significantly speed up the recovery of the low resolution scene. Such a “fast” MSS matrix has the key capability of generating a high-quality preview of the scene (see FIGS. 4A-4C) with very low computational complexity; this is beneficial for video CS as it allows us to easily extract an estimate of the scene motion. The motion estimate can then be used to recover the video at its full resolution. In addition to this, the use of fast MSS matrices can be beneficial in various other ways, including (but not limited to):

Real-time preview: Conventional SMC architectures do not enable the observation of the scene until CS recovery is performed. Due to the high computational complexity of most existing CS recovery algorithms, there is typically a large latency between the acquisition of a scene and its observation. Fast MSS matrices offer an instantaneous visualization of the scene, i.e., they can provide us with a real-time digital viewfinder. This capability substantially simplifies the setup of an SMC in practice.

### Adaptive Sensing

The immediate knowledge of the scene—even at a low resolution—can potentially be used to design adaptive sensing strategies. For example, one may seek to extract the changes that occur in a scene from one frame to the next or track moving objects, while avoiding the latency caused by sparse signal recovery algorithms.

### Sensing Matrix Design

There are many ways to construct fast MSS matrices. In this section, we detail one design that is particularly suited for SMC architectures. In SMC architectures, we are constrained in the choice of the sensing matrix Φ. Practically, the DMD limits us to matrices having entries of constant modulus (e.g., ±1). Since we are interested in a fast MSS matrix, we propose the matrix Φ to satisfy H=ΦU, where H is a W×W Hadamard matrix and U is a predefined up-sampling operator. For SMC architectures, Hadamard matrices have the following advantages: i) They have orthogonal columns, ii) they exhibit optimal SNR properties over matrices restricted to {−1,+1} entries, and iii) applying the (inverse) Hadamard transform requires very low computational complexity (i.e., as a fast Fourier transform). See, M. Harwit and N. Sloane, Hadamard Transform Optics, New York: Academic Press, 1979; Y. Y. Schechner, S. K. Nayar, and P. N. Belhumeur, “Multiplexing for optimal lighting,” IEEE Trans. Pattern Anal. Mach. Intell., vol. 29, pp. 1339-1354, August 2007.

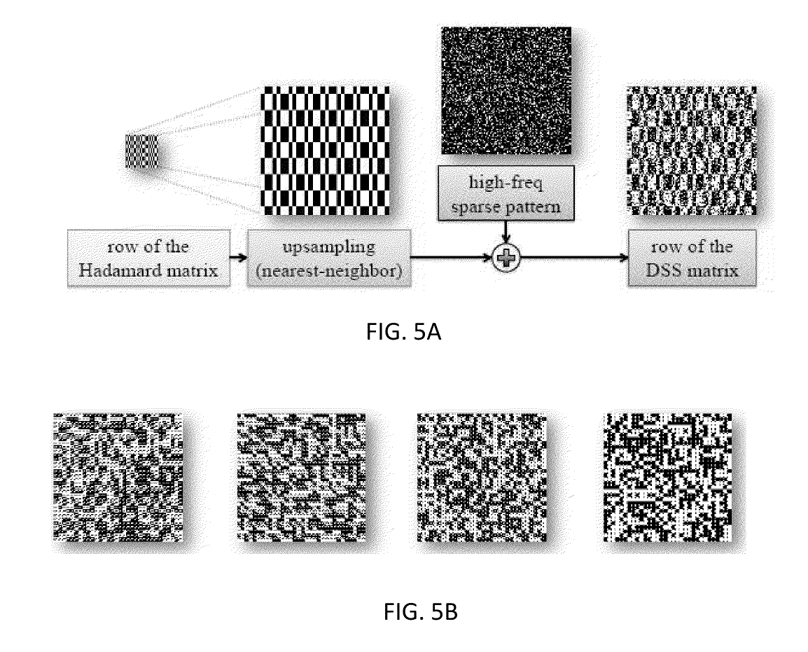

We now show the construction of a suitable fast MSS matrix Φ for two scales (for the preview frames at a given low resolution and the full resolution frames), referred to as dual-scale sensing (DSS) matrix (see FIG. 5A). A simple way is to start with a W×W Hadamard matrix H and to write the CS matrix as

Φ=HD+F, (7)

where D is a down-sampling matrix satisfying DU=I, and Fε [symbol] ^{W×N} is an auxiliary matrix that obeys the following constraints: i) The entries of Φ are ±1, ii) the matrix Φ has good CS recovery properties (e.g., satisfies the RIP), and iii) F should be chosen such that FU=0. Note that an easy way to ensure that Φ be ±1 is to interpret F as sign flips of the Hadamard matrix H. Note that one could chose F to be an all-zeros matrix; this choice, however, results in a sensing matrix Φ having poor CS recovery properties.

In particular, such a matrix would inhibit the recovery of high spatial frequencies. Choosing random entries in F such that FU=0 (i.e., by using random patterns of high spatial frequency) provides excellent performance. To arrive at an efficient implementation of CS-MUVI, we additionally want to avoid the storage of an entire W×N matrix. To this end, we generate each row fᵢε [symbol] ^{N} as follows: Associate each row vector fᵢ to an n×n image of the scene, partition the scene into blocks of size (n/n_{L})×(n/n_{L}), and associate an (n/n_{L})²-dimensional vector \hat{f}ᵢ with each block. We can now use the same vector \hat{f}ᵢ for each block and choose \hat{f}ᵢ such that the full matrix satisfies FU=0. We also permute the columns of the Hadamard matrix H to achieve better incoherence with the sparsifying bases (see FIG. 5B for the details).

Optical-Flow-Based Video Recovery

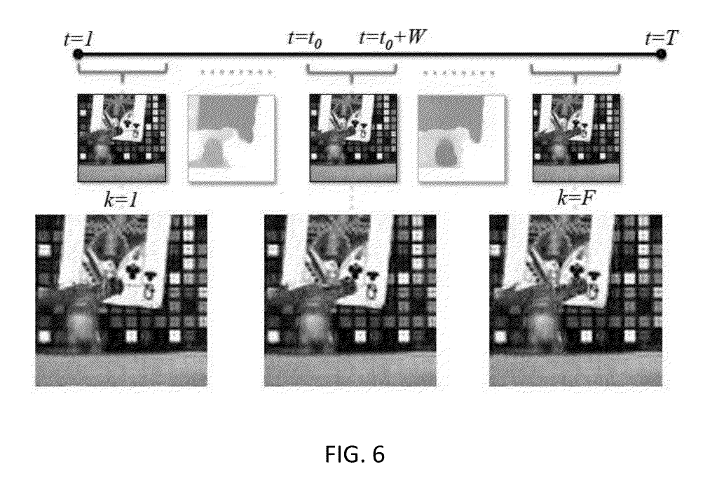

We next detail the second part of CS-MUVI. FIG. 6 illustrates the method used to recover the full-resolution video frames (see also the flowchart in FIG. 1A). As shown in FIG. 6, a total number of samples T are taken. There are W measurements 610 per preview frame 620.

### Optical Flow Estimation

Thanks to the preview mode, we can estimate the optical flow between any two (low-resolution) frames \hat{b}_{L}ⁱ and \hat{b}_{L}^{j}. For CS-MUVI, we compute optical-flow estimates at full spatial resolution between pairs of upsampled preview frames; this approach turns out to result in more accurate optical-flow estimates compared to an approach that first estimates the optical flow at low resolution followed by upsampling of the optical flow. Hence, we start by upsampling the preview frames according to \hat{b}_{L}ⁱ=U\hat{b}_{L}ⁱ or via a conventional upsampling procedure (e.g., linear or bicubic interpolation,), and then extract the optical flow at full resolution. The optical flow at full resolution can be written as

\hat{b}ⁱ(x,y)=\hat{b}^{j}(x+u_{x,y},y+v_{x,y})

where \hat{b}ⁱ(x,y) denotes the pixel (x,y) in the n×n plane of \hat{b}ⁱ, and u_{x,y} and v_{x,y} correspond to the translation of the pixel (x,y) between frame i and j. See, C. Liu, Beyond Pixels: Exploring New Representations and Applications for Motion Analysis. PhD thesis, Mass. Inst. Tech., 2009 and B. Horn and B. Schunck, “Determining optical flow,” Artif. Intel., vol. 17, pp. 185-203, April 1981. Other methods to compute the optical flow rely on block matching, which is commonly used in many video compression schemes.

In practice, the estimated optical flow may contain subpixel translations, i.e., u_{x,y} and v_{x,y} are not necessarily integers. In this case, we approximate \hat{b}^{j}(x+u_{x,y},y+v_{x,y}) as a linear combination of its four closest neighboring pixels

$${\hat{b}}^{j} ( x + {u}_{x , y} , y + {v}_{x , y} ) \approx {\sum }_{k , 𝓁 ∈ \{ 0 , 1 \}}^{ } {w}_{k , 𝓁} {\hat{b}}^{j} ( ⌊ x + {u}_{x , y} ⌋ + k , ⌊ y + {v}_{x , y} ⌋ + 𝓁 )$$

where └•┘ denotes rounding towards −∞ and the weights W_{k,l} are chosen according to the location within the four neighboring pixels. In order to obtain robustness against occlusions, we enforce consistency between the forward and backward optical flows; specifically, we discard optical flow constraints at pixels where the sum of the forward and backward flow causes a displacement greater than one pixel.

### Choosing the Recovery Frame Rate

Before we detail the individual steps of the CS-MUVI video-recovery procedure, it is important to specify the rate of the frames to be recovered. When sensing scenes with SMC architectures, there is no obvious notion of frame rate. Our sole criterion is that we want each “frame” to contain only a small amount of motion. In other words, we wish to find the largest window size ΔW≦W such that there is virtually no motion at full resolution (n×n). In practice, an estimate of ΔW can be obtained by analyzing the preview frames. Hence, given a total number of T compressive measurements, we ultimately recover F=T/ΔW full-resolution frames (see FIG. 6). Note that a smaller value of ΔW would decrease the amount of motion associated with each recovered frame; this would, however, increase the computational complexity (and memory requirements) substantially as the number of full-resolution frames to be recovered increases.

### Recovery of Full Resolution Frames

We are now ready to detail the final steps of CS-MUVI. Assume that ΔW is chosen such that there is little to no motion associated with each preview frame. Next, associate a preview frame with a high-resolution frame \hat{x}ₖ, kε{1, . . . , T} by grouping W=N_{L} compressive measurements in the immediate vicinity of the frame (since ΔW<W). Then, compute the optical-flow between successive (up-scaled) preview frames.

We can now recover the individual high-resolution video frames as follows. Each frame \hat{x}ₜ is assumed to have a sparse representation in a 2-dimensional orthogonal wavelet basis Ψ; hence, our objective is to minimize the overall l-norm Σₖ₌₁^{F}∥Ψ^{T}\hat{x}ₖ∥₁. We furthermore consider the following two constraints: i) Consistency with the acquired CS measurements, i.e, [symbol] φₜ,\hat{x}_{I(t)} [symbol] , where I(t) maps the sample index t to the associated frame index k, and ii) estimated optical-flow constraints between consecutive frames. Together, we arrive at the following convex optimization problem:

$$( PV ) \{ \begin{matrix}min . {\sum }_{k = 1}^{F} {‖ {Ψ}^{T} {{x}^{′}}_{k} ‖}_{1} \\ s . t . \begin{matrix}{‖ 〈 {φ}_{t} , {\hat{x}}_{I ( t )} 〉 - {y}_{t} ‖}_{2} \leq {ε}_{1} , ∀ t \\ {‖ {\hat{x}}_{i} ( x , y ) - {\hat{x}}_{j} ( x + {u}_{x} , y + {v}_{y} ) ‖}_{2} \leq {ε}_{2} , ∀ i , j .\end{matrix}\end{matrix}$$

which can be solved using off-the-shelf algorithms tuned to solve c-recovery problems. See, for example, E. van den Berg and M. P. Friedlander, “Probing the Pareto frontier for basis pursuit solutions,” SIAM J. Scientific Comp., vol. 31, pp. 890-912, November 2008. The parameters ε₁≧0 and ε₂≧0 can be used to “tweak” the recovery performance Alternatively, we can recover the scene via total variation (TV)-based methods. Such approaches essentially amount to replacing the l₁-norm constraint by the total variation norm. See, for example, Rudin, Leonid I., Stanley Osher, and Emad Fatemi. “Nonlinear total variation based noise removal algorithms” Physica D: Nonlinear Phenomena 60, no. 1 (1992): 259-268.

### Experiments

WW We validate the performance and capabilities of the CS-MUVI framework for several scenes. All simulation results were generated from video sequences having a spatial resolution of n×n=256×256 pixels. The preview videos have a spatial resolution of 64×64 pixels with (i.e., W=4096). We assume an SPC architecture as described in M. F. Duarte, M. A. Davenport, D. Takhar, J. N. Laska, T. Sun, K. F. Kelly, and R. G. Baraniuk, “Single-pixel imaging via compressive sampling,” IEEE Signal Process. Mag., vol. 25, pp. 83-91, March 2008. Noise was added to the compressive measurements using an i.i.d. Gaussian noise model such that the resulting SNR was 60 dB. Optical-flow estimates were extracted using C. Liu, Beyond Pixels: Exploring New Representations and Applications for Motion Analysis. PhD thesis, Mass. Inst. Tech., 2009 and (PV) is solved using SPGL1. See, E. van den Berg and M. P. Friedlander, “Probing the Pareto frontier for basis pursuit solutions,” SIAM J. Scientific Comp., vol. 31, pp. 890-912, November 2008. The computation time of CS-MUVI is dominated by solving (PV), which requires 2-3 hours using an off-the-shelf quad-core CPU. The low-resolution preview is, of course, extremely fast.

Synthetic Scene with Sub-Pixel Motion

In FIG. 1 we simulate a fast-moving object that traverses the entire field of-view of the camera within the considered number of samples T. The goal of this synthetic experiment is to emulate a scene that changes for every compressive measurement. To this end, we simulated sub-pixel movement of the foreground object, i.e., there is a small movement of the cross for every compressive measurement. We acquired a total of T=256² compressive measurements and generated F=31 preview frames (ΔW=2048) from which we estimated the respective optical flows. FIG. 1A shows both the efficacy of the proposed DSS measurement matrix for providing robust LS estimates for the preview video (see also FIGS. 4A-4C), as well as the quality of the recovered scene.

Video Sequences from a High-Speed Camera

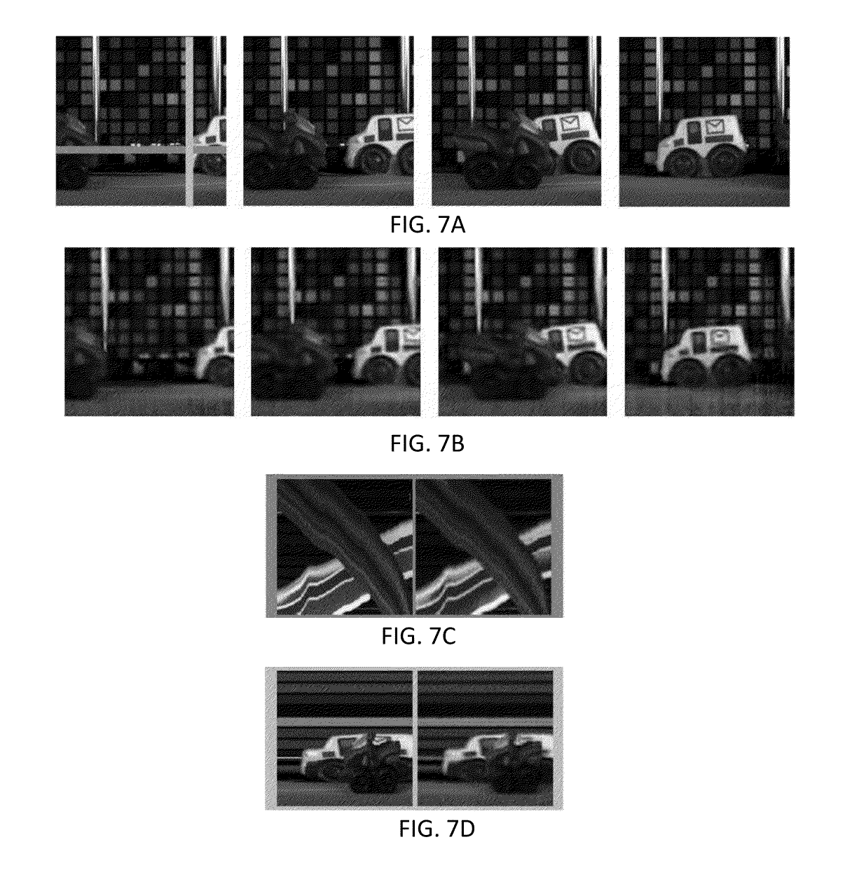

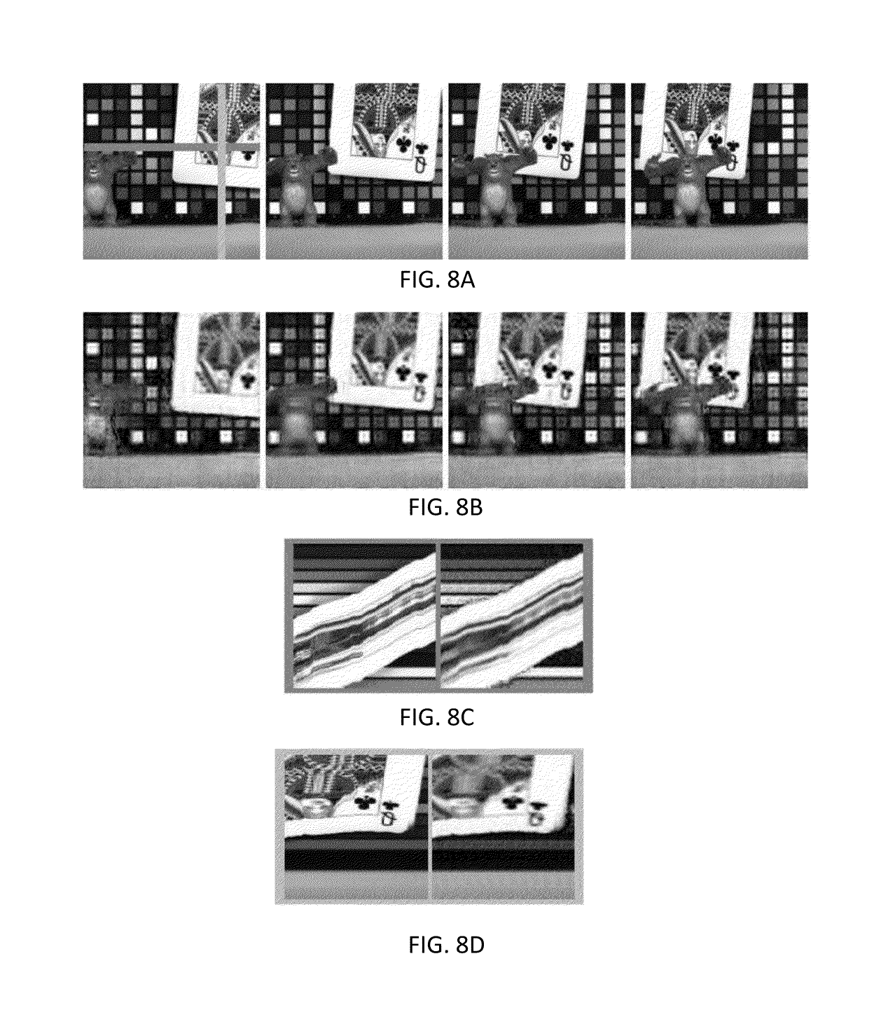

The results shown in FIGS. 7A-7D and 8A-8D correspond to scenes acquired by a high-speed (HS) video camera operating at 250 frames per second. Both videos show complex (and fast) movement of large objects as well as severe occlusions. For both sequences, we emulate an SPC operating at 8192 compressive measurements per second. For each video, we used 2048 frames of the HS camera to obtain a total of T=32×2048 compressive measurements. The final recovered video sequences consist of F=61 frames (ΔW=1024). Both recovered videos demonstrate the effectiveness of CS-MUVI.

Comparison with the P2C2 Algorithm:

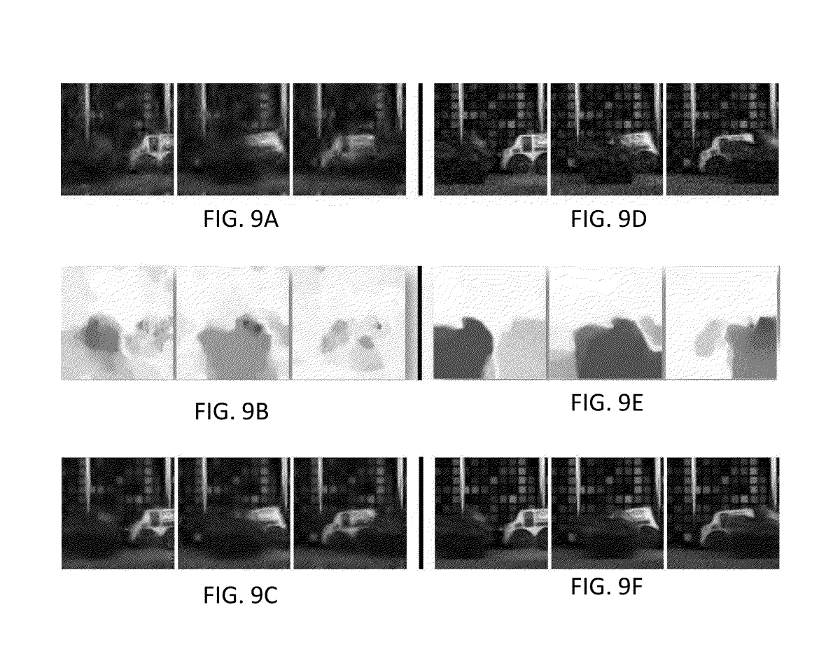

FIG. 9 compares CS-MUVI to the recovery algorithm for the P2C2 camera. Note that the P2C2 camera algorithm was developed for temporal multiplexing cameras and not for SMC architectures. Nevertheless, we observe from FIGS. 9A and 9D that naïve l-norm recovery delivers significantly worse initial estimates than the preview mode of CS-MUVI. The advantage of CS-MUVI for SMC architectures is also visible in the corresponding optical-flow estimates (see FIGS. 9B and 9E. The P2C2 recovery algorithm has substantial artifacts, whereas CS-MUVI recovery is visually pleasing.

There are some artifacts visible in FIGS. 1D, 7A-7D, and 8A-8D. The major portion stems from inaccurate optical-flow estimates—a result of residual noise in the preview images. It is worth noting, however, that the off-the-shelf optical-flow estimation algorithm used in the examples ignores the continuity of motion across multiple frames. Significant performance improvements may be achieved if a multi-frame optical-flow estimation is used.

A smaller portion of the recovery artifacts is caused by using dense measurement matrices, which spread local errors (such as those from the inaccurate optical-flow estimates) across the entire image. This problem is inherent to imaging with SMCs that involve a high degree of spatial multiplexing; imaging architectures that perform only local spatial multiplexing (such as the P2C2 camera) do not suffer from this problem.

The videos in FIGS. 7A-7D and 8A-8D have 256×256×61 pixels and were obtained from 256² compressive measurements; hence, a naïve estimate would suggest a compression of 61×. However, the blur in the recovered videos suggest that the finest spatial frequencies are not present.

Since CS-MUVI relies on optical-flow estimates obtained from low-resolution images, it can fail to recover small objects with rapid motion. More specifically, moving objects that are of sub-pixel size in the preview mode are lost. FIGS. 7A-7B show an example of this limitation. The cars are moved using fine strings, which are visible in FIG. 7A but not in FIG. 7B. Increasing the spatial resolution of the preview images eliminates this problem at the cost of more motion blur. To avoid these limitations altogether, one must increase the sampling rate of the SMC.

The foregoing description of the preferred embodiment of the invention has been presented for purposes of illustration and description. It is not intended to be exhaustive or to limit the invention to the precise form disclosed, and modifications and variations are possible in light of the above teachings or may be acquired from practice of the invention. The embodiment was chosen and described in order to explain the principles of the invention and its practical application to enable one skilled in the art to utilize the invention in various embodiments as are suited to the particular use contemplated. It is intended that the scope of the invention be defined by the claims appended hereto, and their equivalents. The entirety of each of the aforementioned documents is incorporated by reference herein.

What is claimed is:

1. A method for video compressive sensing for spatial multiplexing cameras comprising:
sensing a time-varying scene with a spatial multiplexing camera;
computing a least squared estimate of a sensed scene;
generating a low-resolution preview video of said sensed scene using a computed least squares estimate of said sensed scene;
estimating an optical flow of said time-varying scene using said low-resolution preview video;
recovering a full resolution video of said sensed time-varying scene using sparse signal recovery algorithms.

2. A method according to claim 1, further comprising displaying a generated low-resolution preview video on a display.

3. A method according to claim 1, further comprising displaying a recovered full resolution video of said time-varying scene.

4. A method according to claim 1, wherein said step of sensing a time-varying scene with a spatial multiplexing camera comprising sensing a time-varying scene with a P2C2 camera.

5. A method according to claim 1, wherein sensing patterns used in sensing said time-varying scene are generated using a multi-scale sensing (MSS) matrix.

6. A method according to claim 5, wherein the MSS matrix has a fast transform when right-multiplied by upsampling operators.

7. A method according to claim 5, wherein the MSS matrix is designed for two scales.

8. A method according to claim 5, wherein a downsampled version of the sensing matrix is orthogonal.

9. A method according to claim 5, wherein a downsampled version of the sensing matrix has a fast inverse transform.

10. A method according to claim 1, wherein said optical flow is approximated using block-matching techniques.

11. A method according to claim 1, wherein said optical flow is computed using an upsampled version of the preview frames.

12. A method according to claim 1, wherein information about the scene is extracted from the low-resolution preview.

13. A method according to claim 12, wherein the extracted information comprises the location, intensity, speed, distance, orientation, and/or size of objects in the scene.

14. A method according to claim 12, wherein information about the scene is taken into account in the recovery procedure of the high-resolution video.

15. A method according to claim 12, wherein subsequent sensing patterns are automatically adapted based on extracted information.

16. A method according to claim 12, wherein parameters (optics, shutter, orientation, aperture etc.) of said spatial multiplexing camera are automatically or manually adjusted using the extracted information.

17. A method according to claim 12, wherein dynamic foreground and static background are separated.

18. A method according to claim 1, wherein said recovery is performed using l1-norm minimization.

19. A method according to claim 1, wherein said recovery is performed using total variation minimization.

20. A method according to claim 1, wherein said recovery is performed using greedy algorithms.
